(19) United States
(12) Patent Application Publication
(10) Pub. No.: US 2021/0080178 A1
(43) Pub. Date: Mar. 18, 2021

(54) METHOD FOR DRYING WOOD USING MICROWAVE

(71) Applicant: PACEP CO., LTD., Daejeon (KR)

(72) Inventors: Su Hun PARK, Seongnam-si (KR); Chan Il PARK, Daejeon City (KR); Hyun Seung KIM, Daejeon (KR)

(73) Assignee: PACEP CO., LTD., Daejeon (KR)

(21) Appl. No.: 17/050,241

(22) PCT Filed: Jun. 27, 2019
(86) PCT No.: PCT/KR2019/007824

§ 371 Date: Oct. 23, 2020

(30) Foreign Application Priority Data
Jun. 28, 2018 (KR) 10-2018-0074640

(51) Int. Cl. F26B 3/347; B27K 3/02; B27K 5/00

(52) U.S. Cl. CPC F26B 3/347; F26B 2210/16; B27K 5/0055; B27K 3/0214

(57) ABSTRACT

The present invention relates to a method for drying wood by using microwaves. The method for drying wood by using microwaves, according to an embodiment of the present invention, comprises the steps of: preparing wood; wrapping at least a portion of the wood by using a wrapping member; applying microwaves to the wood wrapped with the wrapping member to raise the temperature inside the wrapping member; removing the wrapping member from the wood wrapped with the wrapping member; and drying moisture of an outer layer of the wood from which the wrapping member has been removed.

### TECHNICAL FIELD

The present invention relates to a method for drying wood using microwaves. An embodiment of the present invention includes a step of wrapping wood with a wrapping member, so that an efficient and economical method for drying wood can be provided.

[symbol]

### BACKGROUND ART

The moisture content (water content) of wood that has been cut is too high to be used for specific purposes such as construction. If the wood having the high moisture content is used, tilting, deformation, and severe cracking may occur over time, and durability may become poor due to the growth of molds or pests, resulting in a problem that the lifespan decreases. In addition, dried wood has advantages compared to non-dried wood in that the processing and handling area easy because the strength is increased by 2 to 3 times and the weight is decreased. Therefore, in order to use the cut wood for a specific purpose such as construction, a drying process is required to allow the cut wood to have a predetermined moisture content.

The wood is dried through a natural drying method and an artificial drying method.

According to the natural drying method, the wood is exposed to the atmosphere so that the moisture content of the wood is naturally decreased. In general, woods are stacked in cross each other, covered with a cover, and left at the room temperature. However, such a natural drying method takes a long time, and there is a problem in that it is difficult to obtain the moisture content required for a specific application.

According to the artificial drying method, woods are placed in an artificially controlled environment such that the moisture content of the woods can be controlled. The artificial drying method is classified as a hot-air drying method, a vacuum drying method, and a dehumidification drying method depending on the method of controlling the environment. The hot-air drying method is for controlling the moisture content by heating and circulating air using steam or electric heat, the vacuum drying method is for controlling the moisture content in the pressure condition under the atmospheric pressure condition, and the dehumidification method is for controlling the moisture content by lowering the humidity in the air. For reference, Korean Patent Registration No. 10-1721797 discloses an artificial drying method for drying wood using a heat medium heater 40.

The conventional artificial drying method has a problem in that excessive energy is consumed to heat the air or lower the air pressure, resulting in an increase in drying cost, and it is difficult to control the moisture content at the center of the wood because the wood is heated from the surface of the wood.

[symbol]

### DETAILED DESCRIPTION OF THE INVENTION

### Technical Problem

An object of the present invention is to provide a method for drying wood using microwaves that can efficiently control the moisture content of wood.

In addition, since it is possible to heat the inside and outside of the wood, the moisture content can be controlled throughout the entire wood, thereby preventing deformation and excessive cracking of the wood, and it can sterilize even the deep part of the wood, so an additional sterilization process is unnecessary and damage by pests can be prevented.

Further, it is economical and efficient because heat applied to the wood can be trapped.

In addition, since it is possible to remove harmful insects and germs inside the wood, an additional sterilization work is unnecessary after the drying process, so the economic advantage can be achieved.

[symbol]

### Technical Solution

A method for drying wood by using microwaves according to an embodiment of the present invention includes the steps of: preparing wood; wrapping at least a portion of the wood by using a wrapping member; applying microwaves to the wood wrapped with the wrapping member to raise a temperature inside the wrapping member; removing the wrapping member from the wood wrapped with the wrapping member; and drying moisture of an outer layer of the wood from which the wrapping member has been removed.

In the step of applying microwaves to the wood wrapped with the wrapping member to raise a temperature inside the wrapping member, the microwaves applied from an outside may penetrate into the wrapping member such that the microwaves are incident into an inside of the wrapping member.

The wrapping member may form a moisture film between an outer skin of the wood and the wrapping member.

The wrapping member may include at least one of polyvinyl chloride (PVC), polyethylene (PE), ethylene vinyl acetate (EVA) copolymer, ethylene-octene copolymer (POE), polypropylene (PP), oriented polypropylene (OPP), polyethylene terephthalate (PET), oriented polystyrene (OPS), polycarbonate (PC), low density polyethylene (LDPE), and acrylic resin.

In the step of applying microwaves to the wood wrapped with the wrapping member to raise a temperature inside the wrapping member, the wood may be heated at a temperature of 100 to 150° C.

[symbol]

### Advantageous Effects of the Invention

The wood drying method using microwaves according to an embodiment of the present invention can efficiently control the moisture content of wood.

In addition, since it is possible to heat the inside and outside of the wood, the moisture content can be controlled throughout the entire wood, thereby preventing deformation and excessive cracking of the wood, and it can sterilize even the deep part of the wood, so an additional sterilization process is unnecessary and damage by pests can be prevented.

Further, it is economical and efficient because heat applied to the wood can be trapped.

In addition, since it is possible to remove harmful insects and germs inside the wood, an additional sterilization work is unnecessary after the drying process, so the economic advantage can be achieved.

[symbol]

### DESCRIPTION OF THE DRAWINGS

FIG. 1 is a flowchart of a method for drying wood using microwaves according to an embodiment of the present invention.

FIG. 2 is a view showing wood wrapped with a wrapping member.

FIGS. 3 and 4 are views showing a step of heating wood wrapped with a wrapping member in a microwave wood drying apparatus.

FIG. 5 is a view showing moisture contained inside a wrapping member.

FIG. 6 is a view showing a section of wood dried by using a radiator.

FIG. 7 is a view showing a section of wood dried by using microwaves without a wrapping member.

FIG. 8 is a view showing a section of wood dried through a method for drying wood using microwaves according to an embodiment of the present invention.

[symbol]

### MODE FOR INVENTION

Hereinafter, preferred embodiments of the present invention will be described with reference to the accompanying drawings. However, embodiments of the present invention may be modified in various other forms, and the scope of the present invention is not limited to the embodiments described below. In addition, embodiments of the present invention are provided to more completely explain the present invention to those skilled in the art. Accordingly, the shapes and sizes of elements in the drawings may be exaggerated for clearer explanation, and elements indicated by the same reference numerals in the drawings are the same elements. In addition, the same reference numerals are assigned to the elements having similar functions and operations throughout the drawings. In addition, unless specifically described to the contrary, the expression “includes” some elements means that other elements may be further included but not excluded, unless specifically described to the contrary, it means that other elements may be further included but not excluded.

[symbol]

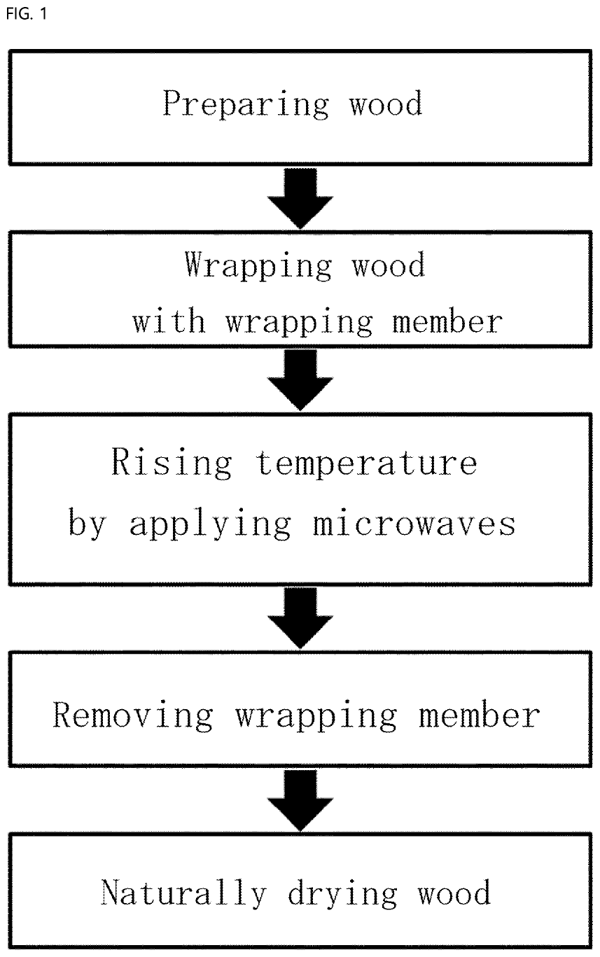

FIG. 1 is a flowchart of a method for drying wood using microwaves according to an embodiment of the present invention. Referring to FIG. 1, the method for drying wood using microwaves according to an embodiment of the present invention may include the steps of preparing wood; wrapping at least a portion of the wood by using a wrapping member; applying microwaves to the wood wrapped with the wrapping member to raise a temperature inside the wrapping member; removing the wrapping member from the wood wrapped with the wrapping member; and drying moisture of an outer layer of the wood from which the wrapping member has been removed.

[symbol]

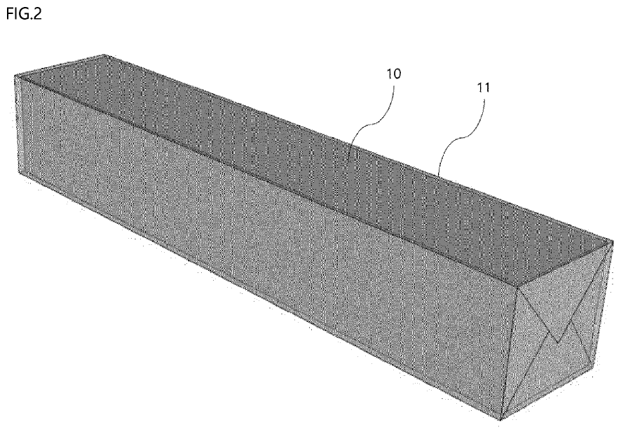

A step of preparing wood and a step of wrapping at least a portion of the wood using a wrapping member are performed. The wood may be partially or entirely wrapped with the wrapping member. When the wood is entirely wrapped with the wrapping member as shown in FIG. 2, heat inside the wrapping member may be preserved well, so that the cost and time required to heat the wood can be reduced.

[symbol]

The wrapping member may allow the microwaves applied from the outside to penetrate into the wrapping member such that the microwaves may enter the inside of the wrapping member. According to an embodiment of the present invention, the wood may be heated by using microwaves. In this case, it is necessary to irradiate the microwaves such that the microwaves are incident into the inside of the wood to evenly heat the inside and the outside of the wood. The wrapping member may be formed of a material having sufficient permeability with respect to the microwaves to allow the microwaves to penetrate into the inside of the wood.

[symbol]

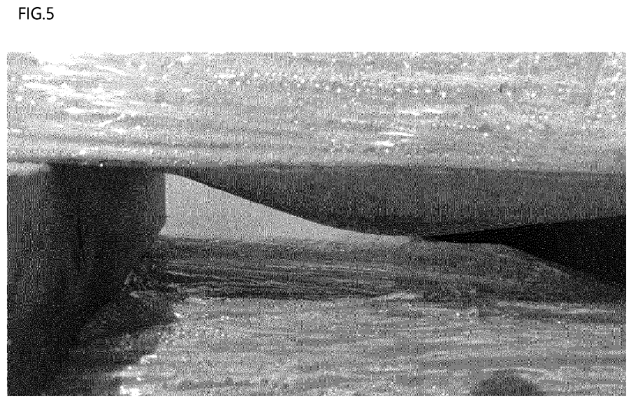

The wrapping member may perform a function of forming a moisture film between the outer skin of the wood and the wrapping member. In the step of heating the wood, moisture inside the wood may be heated so that some of the moisture is discharged to the outside of the wood, but the remaining moisture is blocked by the wrapping member without being discharged out of the wrapping member. The moisture may remain between the outerskin of the wood and the wrapping member and form the moisture film on the outer skin of the wood or the inner surface of the wrapping member (see FIG. 5). The wrapping member may block the outer skin of the wood from the outside. Therefore, it is possible to prevent the moisture discharged from the wood heated by the microwaves from being discharged to the outside. Since the moisture film formed by the wrapping member may absorb the microwaves, the efficiency of heating the wood may be increased in addition, while the wood formed with the wrapping member is being heated, the moisture content inside and outside the wood can be kept constant. Thus, it is possible to prevent the carbonization phenomenon that occurs when only a part of the wood is intensively heated.

In the case of heating the wood by using only the microwaves without using the wrapping member, it is necessary to heat the microwaves continuously or intermittently for a long time to control the moisture content inside the wood. In this case, the temperature of a portion where the microwaves are intensively absorbed may increase rapidly, resulting in carbonization or ignition. Further, in case that the moisture discharged from the wood when the wood is heated by the microwaves is evaporated, the deep part of the wood may have a high moisture content, but the outer part of the wood may have a low moisture content, so that the deep part of the wood may be carbonized. Even if the wood is not carbonized or ignited, there may be a difference in moisture content at various parts of the wood, so excessive cracking may occur in the wood after drying.

In the method of drying the wood using the microwaves according to an embodiment of the present invention, at least a portion of the wood is wrapped by using the wrapping member, so that the moisture and heat may be evenly distributed inside the wrapping member. Accordingly, it is possible to prevent the microwaves from being concentrated on a specific portion of the wood, and the temperature inside and outside the wood can be kept constant. Therefore, carbonization or ignition of the wood can be prevented, the moisture content can be constantly controlled over the whole area of the wood, and the wood can be prevented from being excessively cracked after drying. In addition, it is economical because the heat can be prevented from being discharged to the outside. More preferably, the wood can be more effectively dried by shielding the wood from the outside by wrapping the entire wood using the wrapping member.

[symbol]

The wrapping member may not be particularly limited as long as the microwaves can penetrate the wrapping member and the wrapping member can form the moisture film on the outer skin of the wood. In order to improve the work efficiency and the efficiency of removing moisture inside the wood after the heating process, the wrapping member may include at least one of polyvinyl chloride (PVC), polyethylene (PE), ethylene vinyl acetate (EVA) copolymer, ethylene-octene copolymer (POE), polypropylene (PP), oriented polypropylene (OPP), polyethylene terephthalate (PET), oriented polystyrene (OPS), polycarbonate (PC), low density polyethylene (LDPE), and acrylic resin. The wrapping member may have a shape capable of wrapping the wood to seal the wood from the outside, for example, the wrapping member may have a film shape or a bag shape.

[symbol]

Next, a step of rising the temperature inside the wrapping member by applying the microwaves to the wood wrapped with the wrapping member may be performed.

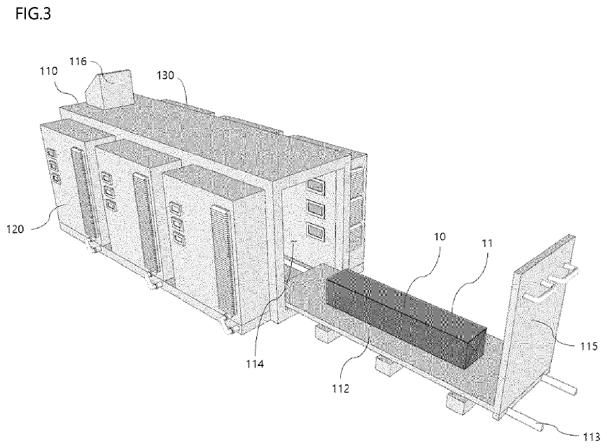

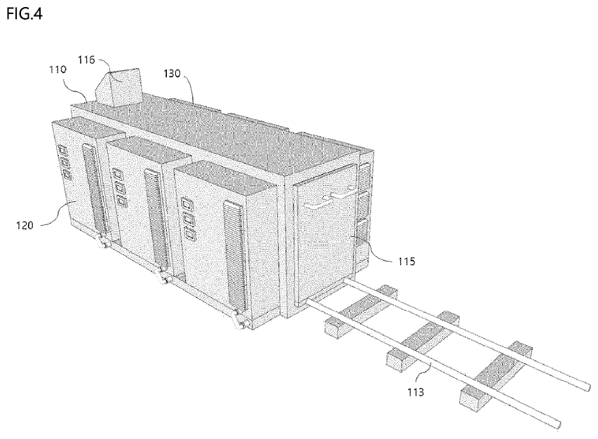

The method of applying the microwaves may not be particularly limited, and the microwave wood drying apparatus shown in FIGS. 3 and 4 may be used. The microwave wood drying apparatus may include a plurality of microwave oscillators arranged at regular intervals so as to evenly distribute the microwaves throughout the wood. In addition, the microwave oscillators may be disposed to face each other with the wood interposed therebetween, so that the moisture content of the entire wood can be evenly controlled. FIG. 3 is a view showing a state in which the wood wrapped with the wrapping member is mounted on the microwave wood drying apparatus, and FIG. 4 is a view showing a step of heating the wood wrapped with the wrapping member after shielding the wood from the outside by closing a door of the microwave wood drying apparatus.

[symbol]

In this step, the wood may be heated at the temperature of 100 to 170° C., preferably 100 to 150° C. If the temperature of the wood is less than 100° C., the moisture inside the wood does not evaporate, so the moisture in the wood may not be sufficiently removed, and the moisture film may not be sufficiently formed on the outer skin of the wood, making it difficult to consistently control the moisture content of the entire wood. If the temperature of the wood is too high, the wood may be locally carbonized or there may be variations in the moisture content at each part of the wood, resulting in the excessive cracking after drying. According to an embodiment of the present invention, since the temperature variation is little inside and outside the wood, the temperature of the wood may have a value obtained by averaging the temperature of the inside and outside of the wood or may be obtained by measuring only the temperature of the inside of the wood for the purpose of convenience of measurement.

In order to control the temperature in this step, it may include the steps of measuring the temperature during the execution of this step and controlling the intensity of the microwaves or the microwave irradiation time in consideration of the measured temperature. In addition, it is possible to control the microwave irradiation condition according to a preset condition without measuring the temperature during the execution of this step in consideration of economic efficiency and to avoid the inconvenience of temperature measurement. In this case, the preset condition may be expressed as a relational formula or a table based on at least one resultant value of an initial moisture content of wood, a size of wood, an intensity of microwaves, a wavelength of microwaves, variables of microwave irradiation time, a moisture content of wood after a process derived according to the above variables, and a temperature of wood. The user may determine the intensity, wavelength, and irradiation time of the microwaves in consideration of the moisture content and size of the wood to be dried by referring to the above relational formula or table.

In this step, the process time may be determined in consideration of the size and moisture content of the wood, and preferably, the process may be performed for 1 to 2 hours. In addition, during the process time, the microwaves may be continuously irradiated with a constant intensity or may be intermittently irradiated.

[symbol]

The microwave wood drying apparatus used in this step is not particularly limited, and microwave modules 120 and 130 including microwave oscillators may be disposed on both sides of the wood 10 (see FIGS. 3 and 4). Specifically, the microwave wood drying apparatus may include a body 110; a first microwave module 120 disposed on a first surface of the body 110 to emit the microwaves into the interior of the body 110 and separable from the body 110; a second microwave module 130 disposed on a second surface of the body 110, which is opposite to the first surface, to emit the microwaves into the body 110 and separable from the body 110; and a drying chamber surrounded by the first microwave module 120 and the second microwave module 130.

The body 110 may include a frame, a work table 112 supporting the wood 10, a rail 113 that provides a passage for movement of the work table 112 and is connected to the outside from the inside of the frame, an inlet port 114 disposed on a third surface of the frame 111, a door 115 for opening and closing the inlet port 114, and a control unit 116 for controlling drying conditions.

The work table 112 may serve to support the wood 10 to be subject to the drying process. For the purpose of convenience of work, the support may be configured to be movable separately from the frame. The support may include a plate for stably supporting the wood 10, and may further include a wheel for moving the rail 113 under the plate.

The door 115 may open and close the inlet port 114. Referring to FIG. 3, the door 115 may be physically connected to the support to move integrally. A worker can easily move the support to the outside of the frame by moving the door 115 to the outside of the frame.

The control unit 116 may control drying conditions by controlling the operation of the first microwave module 120 and the second microwave module 130. The control unit 116 may transmit a command to the first microwave module 120 and the second microwave module 130 in order to control the emission and interruption of the microwaves, emission time, and magnitudes of the microwaves. To this end, the control unit 116 may perform wireless or wireless communication with the first microwave module 120 and the second microwave module 130. The control unit 116 may receive information such as a state of the microwave oscillator, power consumption, and voltage from the first microwave module 120 and the second microwave module 130, and may receive a temperature from a thermometer disposed inside a drying chamber. The control unit 116 may transmit the received information to a display so that the worker may recognize the state and drying conditions of a modular microwave generator.

The first microwave module 120 and the second microwave module 130 may be disposed on the first and second surfaces of the body 110 and may be disposed to face each other. Thus, the interior of the drying chamber may be fully exposed to constant microwaves, so that the entire wood 10 can be evenly dried. The first microwave module 120 and the second microwave module 130 may include microwave oscillators for generating the microwaves and waveguides for providing a moving path of the microwaves emitted from the microwave oscillators. The microwave oscillator and waveguide may be those generally used in the microwave generator and may not be particularly limited. The first microwave module 120 and the second microwave module 130 may include a plurality of microwave oscillators and waveguides. The plurality of microwave oscillators may be disposed to be spaced apart from each other in the vertical direction.

The drying chamber may be a space formed inside the body 110, and may serve as a space in which a process for drying the wood 10 is performed. The drying chamber 160 may be surrounded by the work table 112, the door 115, the first microwave module 120, and the second microwave module.

[symbol]

Next, the steps of removing the wrapping member from the wood wrapped with the wrapping member and drying the moisture on the outer skin of the wood from which the wrapping member has been removed may be performed.

The step of removing the wrapping member from the wood wrapped with the wrapping member may include the steps of removing at least a portion of the wrapping member from the wood to remove the moisture film formed on the outer skin of the wood, and removing the remaining wrapping member from the wood. According to an embodiment of the present invention, the wood is wrapped with the wrapping member, so that a lot of high temperature moisture is formed inside the wrapping member (see FIG. 5). If the entire wrapping member is removed from the wood, contamination or accidents may occur due to the moisture. Therefore, it is preferable to partially remove the wrapping member in order to safely and efficiently remove the moisture.

[symbol]

Then, a step of drying the moisture on the outer skin of the wood from which the wrapping member has been removed may be performed. The drying method may not be particularly limited, and may include a natural drying method in which the wood is left at the room temperature. Since the wood heated by the microwaves has a high temperature, the moisture inside and outside the wood may be quickly dried even by the natural drying method.

[symbol]

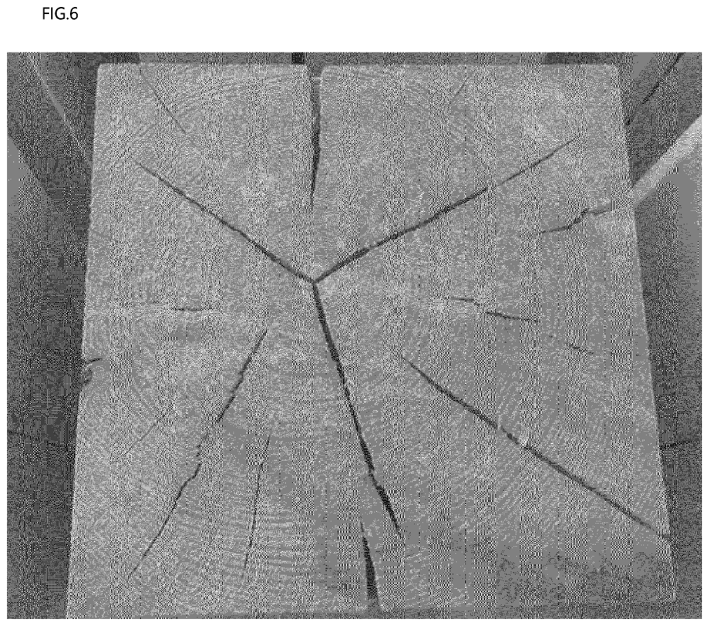

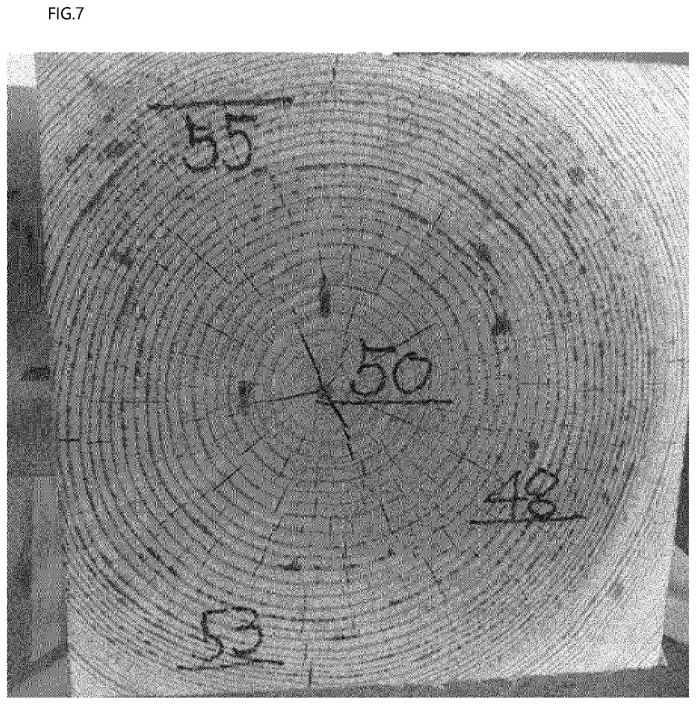

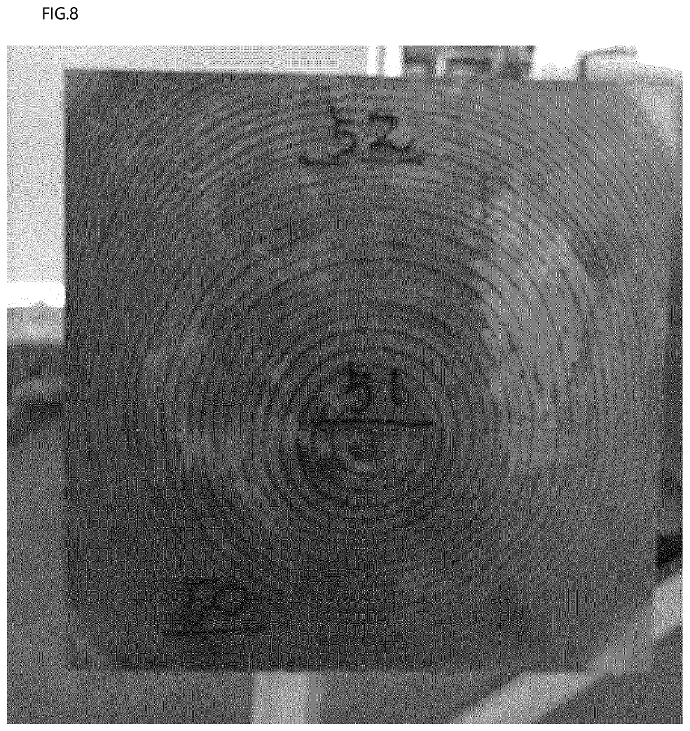

FIG. 6 is a view showing a section of the wood dried by using a radiator, FIG. 7 is a view showing a section of the wood dried by using microwaves without the wrapping member, and FIG. 8 is a view showing a section of the wood dried through a method for drying the wood using microwaves according to an embodiment of the present invention.

Referring to FIG. 6, in the case of the wood dried by using the radiator, thick cracks occur inside and outside the wood. Referring to FIG. 7, in the case of the wood dried by using the microwaves, a number of cracks occur, in which the cracks are thinner than the cracks generated in the wood dried by using the radiator, occur. Referring to FIG. 8, in the case of the wood dried by the drying method using the microwaves according to an embodiment of the present invention, the cracks are significantly reduced.

[symbol]

The present invention is not limited by the above-described embodiments and the accompanying drawings, but is intended to be limited by the appended claims. Therefore, various types of substitutions, modifications and changes will be possible by those skilled in the art without departing from the technical idea of the present invention described in the claims, and these also belong to the scope of the present invention.

[symbol]

### DESCRIPTION OF REFERENCE NUMERALS

10: wood

11: wrapping member

110: body

112: working table

113: rail

114: inlet port

115: door

116: control unit

120: first microwave module

130: second microwave module

1. A method for drying wood by using microwaves, the method comprising the steps of:
preparing wood;
wrapping at least a portion of the wood by using a wrapping member;
applying microwaves to the wood wrapped with the wrapping member to raise a temperature inside the wrapping member;
removing the wrapping member from the wood wrapped with the wrapping member; and
drying moisture of an outer layer of the wood from which the wrapping member has been removed.

2. The method of claim 1, wherein, in the step of applying microwaves to the wood wrapped with the wrapping member to raise a temperature inside the wrapping member, the microwaves applied from an outside penetrate into the wrapping member such that the microwaves are incident into an inside of the wrapping member.

3. The method of claim 1, wherein, in the step of applying microwaves to the wood wrapped with the wrapping member to raise a temperature inside the wrapping member, the wrapping member forming a moisture film between an outer skin of the wood and the wrapping member.

4. The method of claim 1, wherein the wrapping member includes at least one of polyvinyl chloride (PVC), polyethylene (PE), ethylene vinyl acetate (EVA) copolymer, ethylene-octene copolymer (POE), polypropylene (PP), oriented polypropylene (OPP), polyethylene terephthalate (PET), oriented polystyrene (OPS), polycarbonate (PC), low density polyethylene (LDPE), and acrylic resin.

5. The method of claim 1, wherein, in the step of applying microwaves to the wood wrapped with the wrapping member to raise a temperature inside the wrapping member, the wood being heated at a temperature of 100 to 150° C.
